(19) United States
(12) Patent Application Publication
(10) Pub. No.: US 2006/0127206 A1
(43) Pub. Date: Jun. 15, 2006

(54) Hair styling and beauty station and loading assembly

(76) Inventors: Vickie Nolting, Longmont, CO (US); James D. Allen IV, Broomfield, CO (US)

Correspondence Address: Emery L. Tracy, P.O. Box 1518, Boulder, CO, 80306-1518, US

(21) Appl. No.: 11/010,693

(22) Filed: Dec. 10, 2004

(51) Int. Cl. B60P 1/64

(52) U.S. Cl. 414/500

(57) ABSTRACT

A loading assembly for loading, unloading, and transporting an object, the loading assembly securable to a vehicle is provided. The loading assembly comprises an assembly base secured to the vehicle. A tilt rack is pivotally connected to the assembly base. A podium rack is slidable along the assembly base and the tilt rack, the object receivable on the podium rack wherein the loading assembly loads the object from an unloaded vertical position to a loaded horizontal position.

### BACKGROUND OF THE INVENTION

1. Field of the Invention

This invention relates generally to a hair styling and beauty station and loading assembly and, more particularly, the invention relates to a hair styling and beauty station which can be easily loaded and unloaded onto the loading assembly for transporting and storing the hair styling and beauty station.

2. Description of the Prior Art

Portable hair styling stations are known in the art. For instance, the Lamia, U.S. Pat. No. 5,967,632, describes a mobile salon work station. The work station of the Lamia patent includes a frame assembly and work areas equally spaced thereabout having mirrored surfaces, storage compartments, swing out shelves, overhead retractable electrical reels, and an overhead accessory holder. Unfortunately, many problems exist which does not allow the Lamia patent's work station to be easily transported and stored.

For instance, the work station of the Lamia patent is quite complicated and can not be easily transported from one location to the next without a high risk of damaging all or part of the work station. It does not appear that the work station is easily collapsible without substantially dismantling the work station. In addition, the mirrors are left unprotected during transportation and storage thereby greatly increasing the risk of breakage. Furthermore, the small wheels on the work station do not allow the work station to move easily over thresholds and rough terrain.

Currently, work stations, if transportation is desired or necessary, are loaded in and out of a vehicle by manually tipping the work station against the bed of the vehicle then using physical effort to balance, lift, and the slide the work station into the vehicle's cargo area. This procedure is physically difficult, burdensome, and could potentially cause injury to the person loading the work station.

To this end, loading assemblies which maintain an object being loaded and maintained in a horizontal position are known in the art. For instance, the Carpenter, U.S. Pat. No. 4,121,695, describes a hydraulic wheelchair lift for a van-type vehicle. The wheelchair lift of the Carpenter patent has a pivotable frame which can be swung from within to without the vehicle, a slide frame telescopically movable relative to the swing frame, and a wheelchair supporting platform carried at the lower end of the slide frame. The Carpenter patent, however, fails to describe a loading assembly which maintains an object in a horizontal position when loaded and moves to a vertical position when unloaded.

Accordingly, there exists a need for a hair styling and beauty station which can be easily transported from one location to the next without a high risk of damaging all or part of the hair styling and beauty station. Additionally, a need exists for a loading assembly which maintains an object in a horizontal position when loaded and moves to a vertical position when unloaded. Furthermore, there exists a need for a combined hair styling and beauty station and loading assembly which operates together to transport and store the hair styling and beauty station.

### SUMMARY

The present invention is a loading assembly for loading, unloading, and transporting an object, the loading assembly securable to a vehicle. The loading assembly comprises an assembly base secured to the vehicle. A tilt rack is pivotally connected to the assembly base. A podium rack is slidable along the assembly base and the tilt rack, the object receivable on the podium rack wherein the loading assembly loads the object from an unloaded vertical position to a loaded horizontal position.

In addition, the present invention is a method for loading, unloading, and transporting an object. The method comprises securing an assembly base to the vehicle, pivotally connecting a tilt rack to the assembly base, slidably securing a podium rack along the assembly base and the tilt rack; positioning the object on the podium rack, and loading the object from an unloaded vertical position to a loaded horizontal position.

The present invention further includes a loading system for loading an object from a substantially vertical position to a substantially horizontal position and unloading an object from a substantially horizontal position to a substantially vertical position. The loading system comprises a base assembly securable to a substantially horizontal surface. Track means are mounted to the base assembly for moving the object from the base assembly. Pivot means are associated with the track means for rotating at least a portion of the track means into a substantially vertical position. An object support is movable along the track means.

### BRIEF DESCRIPTION OF THE DRAWINGS

FIG. 1 is a front side view illustrating a hair styling and beauty station, constructed in accordance with the present invention;

FIG. 2 is a side view illustrating the hair styling and beauty station of FIG. 1, constructed in accordance with the present invention;

FIG. 3 is a perspective view illustrating the hair styling and beauty station of FIG. 1, constructed in accordance with the present invention;

FIG. 4 is a perspective view illustrating a loading assembly, constructed in accordance with the present invention, with the hair styling and beauty station in a loaded position;

FIG. 5 is a perspective view illustrating the loading assembly of FIG. 4, constructed in accordance with the present invention, with the hair styling and beauty station in a loaded position and a tilt track extended;

FIG. 6 is a perspective view illustrating the loading assembly of FIG. 4, constructed in accordance with the present invention, with the hair styling and beauty station on the tilt track;

FIG. 7 is a perspective view illustrating the loading assembly of FIG. 4, constructed in accordance with the present invention, with the hair styling and beauty station in an unloaded position;

FIG. 8 is a perspective view illustrating an assembly base of the loading assembly, constructed in accordance with the present invention;

FIG. 9 is an elevational side view illustrating the assembly base of the loading assembly of FIG. 8, constructed in accordance with the present invention;

FIG. 10 is a left perspective view of a support arm of the assembly base of the loading assembly, constructed in accordance with the present invention;

FIG. 11 is a right perspective view of the support arm of the assembly base of the loading assembly of FIG. 10, constructed in accordance with the present invention;

FIG. 12 is a perspective view of a tilt rack of the loading assembly, constructed in accordance with the present invention; and

FIG. 13 is a top view of the tilt rack of the loading assembly of FIG. 12, constructed in accordance with the present invention.

### DETAILED DESCRIPTION OF THE PREFERRED EMBODIMENTS

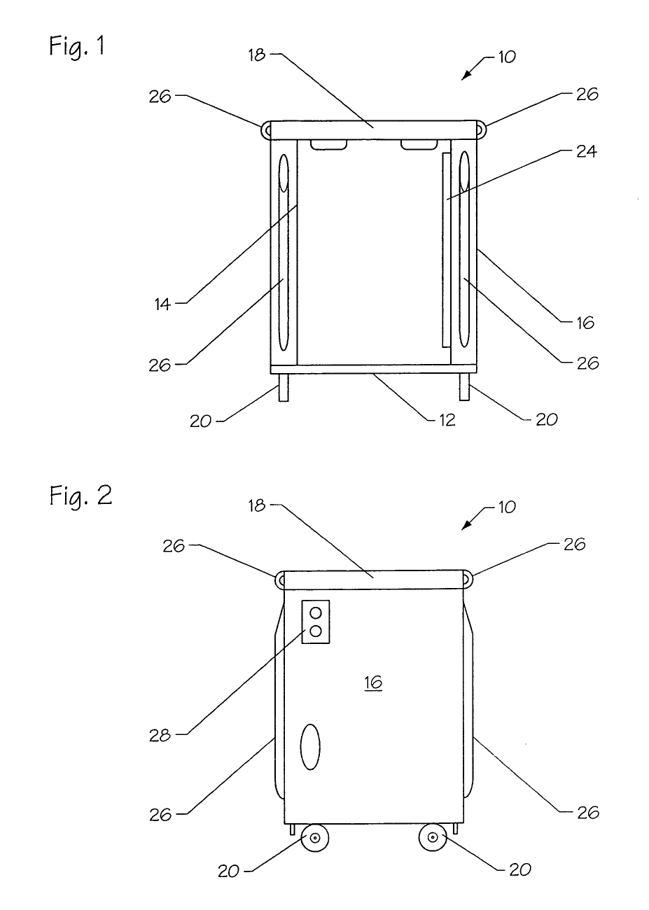

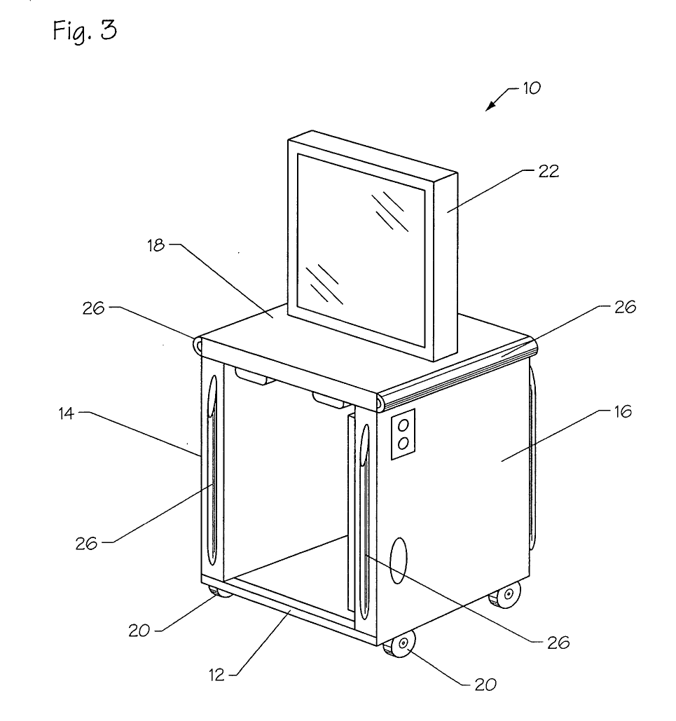

As illustrated in FIGS. 1-3, the present invention is a hair styling and beauty station, indicated generally at 10. The hair styling and beauty station 10 provides a portable work station for performing hair styling and beauty to clients at any desired location.

The hair and beauty station 10 of the present invention includes a base plate 12, a first side wall 14 secured to the base plate 12, a second side wall 16 secured to the base plate 12, and a top plate 18. Wheels 20 mounted to the base plate 12 allow the hair styling and beauty station 10 to move with ease to any desired location. Attaching the wheels 20, especially pneumatic wheels, to the hair styling and beauty station 10 provide easy movement over thresholds and different rough surfaces including snow, gravel, rough pavement, carpet, etc.

The hair styling and beauty station 10 further includes a mirror 22 releasably mountable to the top plate 18. The mirror 22 is receivable within a slot (not shown) on the top plate 18 of the hair styling and beauty station 10. The mirror 22 can be removed from the top plate 18 and inserted into a pocket 24 formed on either the first side wall 14 or the second side wall 16. Furthermore, the mirror 22 has reflective surfaces on both sides allowing two stylists to work on opposite sides of the hair styling and beauty station 10 at the same time.

The hair styling and beauty station 10 of the present invention further includes bumpers 26 mounted on the first and second side walls 14, 16, and the top plate 18. The bumpers 26 reduce the risk of damaging the hair styling and beauty station 10 and other property. Positioning of the bumpers 26 along the sides and/or edges of the hair styling and beauty station 10 is also within the scope of the present invention.

The hair styling and beauty station 10 provides power used in the hairstyling and beauty industry. To this end, the hair styling and beauty station 10 can be connected to a power source. GFI outlets 28 on the hair styling and beauty station 10 provide electrical plugs for hair styling and beauty equipment (not shown) while reducing risks to the stylist and clients.

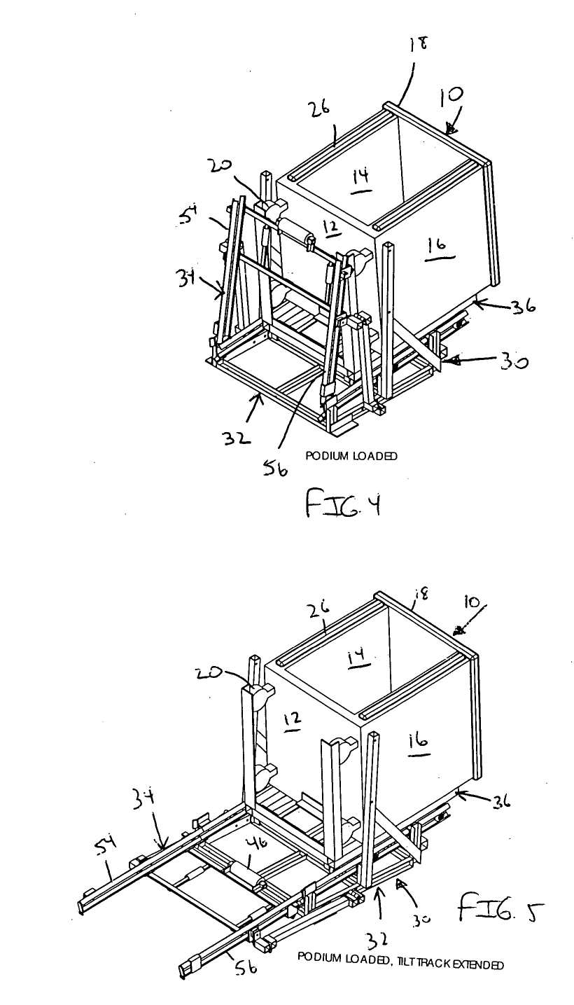

As illustrated in FIGS. 4-13, the present invention further includes a loading assembly 30 for transporting the hair styling and beauty station 10. The loading assembly allows the hair styling and beauty station 10 to be loaded into and unloaded from a vehicle (not shown). It should be noted that the loading assembly 30 has and will be described herein as loading and unloading the hair styling and beauty station 10. It is within the scope of the present invention to use the loading assembly 30 to load and unload any type of equipment or station which moves from a loaded substantially horizontal position to an unloaded vertical position.

The loading assembly 30 of the present invention includes an assembly base 32 mountable to the vehicle, a tilt rack 34 pivotally mounted to the assembly base 32, and a podium rack 36 slidable along the assembly base 32 and the tilt rack 34. The loading assembly 30 incorporates a latch to retain the slides in the closed position to secure the hair styling and beauty station 10 during transport. The hair styling and beauty station 10 is secured to the loading assembly 30 by straps, a latching buckle, or other connecting mechanism (not shown), and multiple supporting framework integrated into the loading assembly 30.

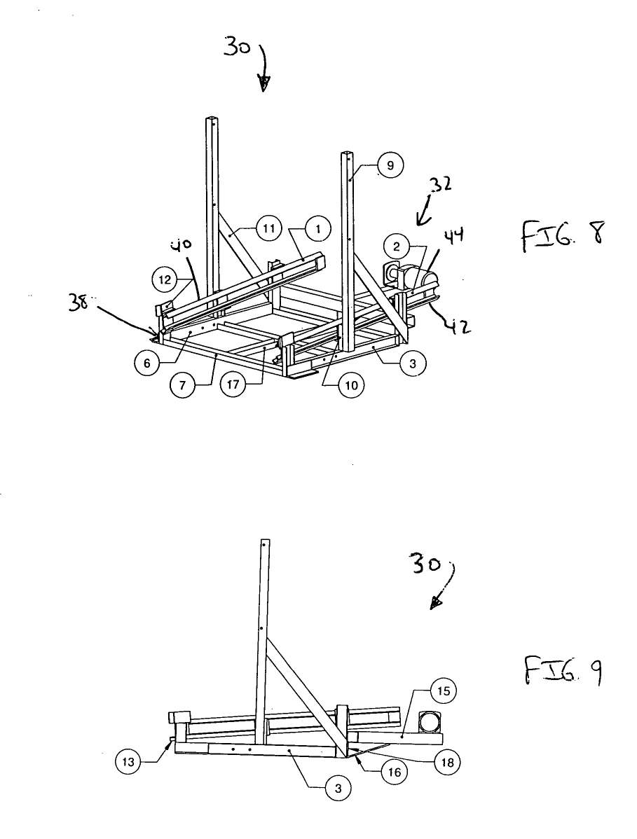

As best illustrated in FIGS. 8 and 9, the assembly base 32 of the loading assembly 30 of the present invention includes a frame 38 mounted to the vehicle. The frame 38 includes a first rail 40 and a second rail 42 substantially opposite and parallel to the first rail 40. Preferably, the first rail 40 and the second rail 42 are angled downward allowing the podium rack 36 to roll down the rails 40, 42, as will be described in further detail below.

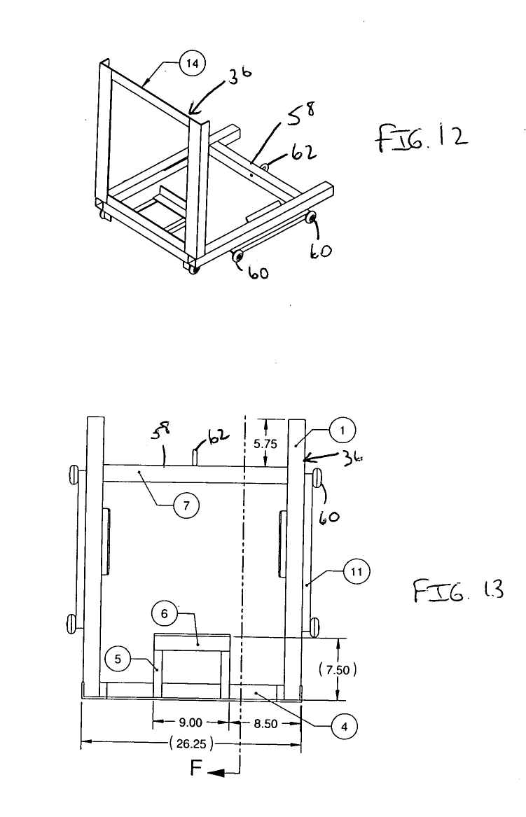

A winch 44 is mounted to the frame 38 for raising hair styling and beauty station 10 into the vehicle, as will be described in more detail below. The winch 44 also controls the lowering of the hair styling and beauty station 10. A cable (not shown) extends from the winch 44 over a roller 46 to a loop 62 (see FIGS. 12 and 13) on the podium rack 36 for raising and lowering the hair styling and beauty station 10, as described in more detail below.

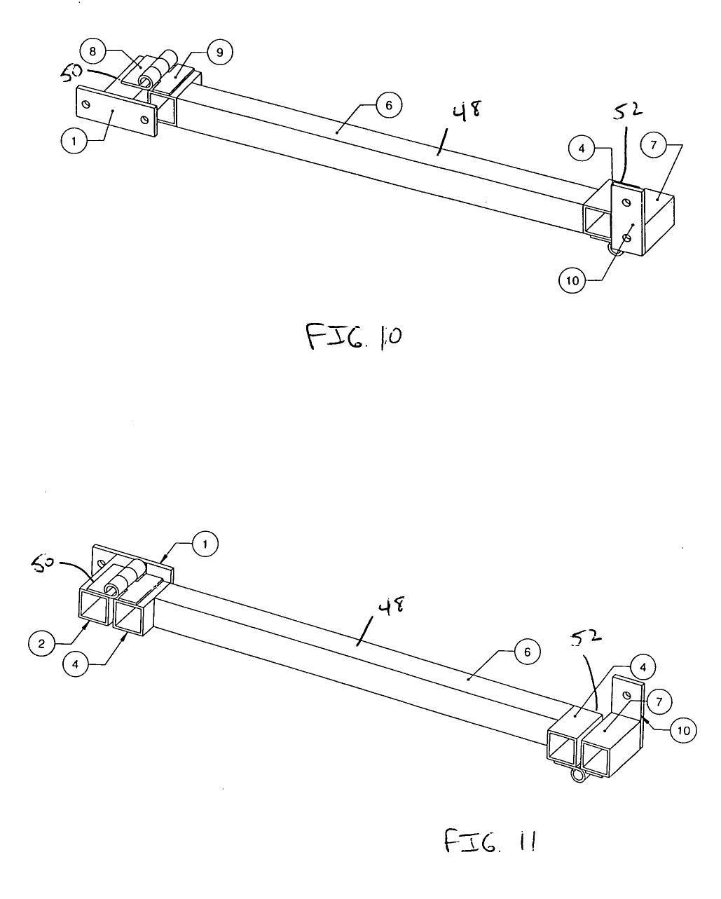

As best illustrated in FIGS. 10 and 11, the assembly base 32 further includes a pair of support arms 48 each having a first end 50 and a second end 52. The first ends 50 of the support arms 48 are hingedly connected to the frame 38. The second ends 52 of the support arms 48 are hingedly connected to the tilt rack 34.

Referring back to FIGS. 4 and 5, the tilt rack 34 of the loading assembly 30 of the present invention includes a first rail 54 and a second rail 56 substantially opposite and parallel to the first rail 54. When unloading the hair styling and beauty station 10 from the vehicle, the tilt rack 34 rotates about the pivot points of the support arms 48 aligning the first rail 54 of the tilt rack 34 with the first rail 40 of the frame 38 of the assembly base 30 and aligning the second rail 56 of the tilt rack 34 with the second rail 42 of the frame 38 of the assembly base 30.

As best illustrated in FIGS. 12 and 13, the podium rack 36 of the loading assembly 30 of the present invention includes a support frame 58 for supporting the hair styling and beauty station 10 during loading and unloading. Wheels 60 on the support frame 58 allow the podium rack 36 to follow and move along the first rails 40, 54 of the assembly base 32 and the tilt rack 34, respectively, and the second rails 42, 56 of the assembly base 32 and the tilt rack 34, respectively.

Operation of the loading assembly 30 of the present invention in loading and unloading the hair styling and beauty station 10 will now be described. It will be understood by those persons skilled in the art that the loading and unloading can be accomplished in a variety of manners and the description herein below is only one such manner.

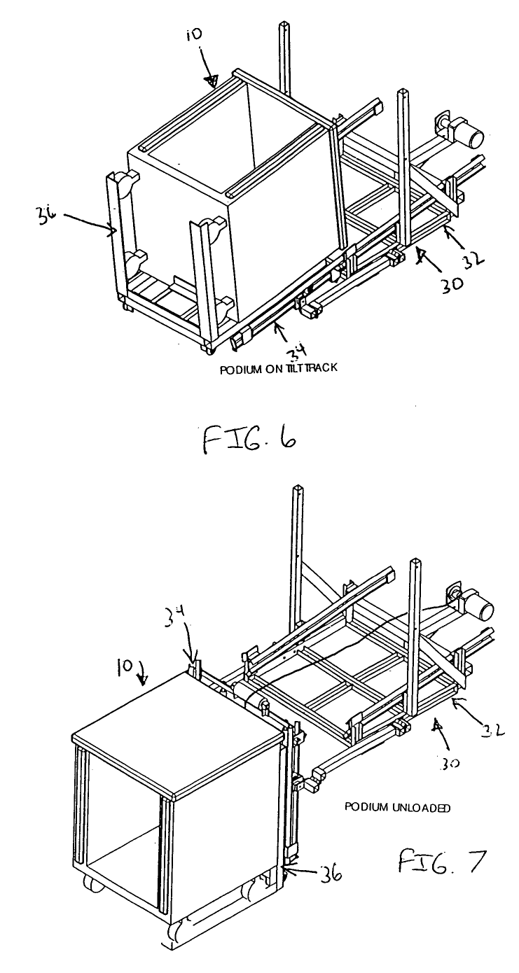

As illustrated in FIG. 4, prior to unloading the hair styling and beauty station 10, the hair styling and beauty station 10 is in a substantially horizontal position releasably secured to the podium rack 36 of the loading assembly 30. As illustrated in FIG. 5, the tilt rack 34 of the loading assembly 30 rotates, either manually or automatically, in a generally downward direction to align the first rails 40, 54 and the second rails 42, 56. As illustrated in FIG. 6, the podium rack 36 travels down the first rails 40, 54 and the second rails 52, 56. As illustrated in FIG. 7, the tilt rack 34 and the podium rack 36 rotate to position the hair styling and beauty station 10 in a substantially vertical position. While gravity causes the podium rack to move along the first rails 40, 54 and the second rails 52, 56, the winch 44 controls the rate of descent of the podium rack 36. The straps securing the hair styling and beauty station 10 to the loading assembly 30 are then removed or otherwise loosened and the hair styling and beauty station 10 is rolled off of the podium rack 36 to a desired location.

To load the hair styling and beauty station 10 onto the loading assembly 30, the hair styling and beauty station 10 is rolled onto the podium rack 36. The straps are then tightened about the hair styling and beauty station 10 to releasably secure the hair styling and beauty station 20 to the podium rack 36. The winch 44 is then activated to urge the podium rack 36 vertically toward the base assembly 32 by rotating the tilt rack 34 and aligning the first rails 40, 54 and the second rails 42, 56 of the assembly base 32 and the tilt rack 34, respectively. The podium rack 36 travels along the first rails 40, 54 and the second rails 52, 56 until the podium rack 36 rests in a substantially horizontal position on the base assembly 32. The tilt rack 34 is then rotated back against the podium rack 36. The hair styling and beauty station 10 is now in a substantially horizontal position.

The loading assembly 30 of the present invention provides an easy method of loading the hair styling and beauty station 10 into and unloading the hair styling and beauty station 10 from a vehicle inhibiting risk to the user. The loading assembly 30 loads the hair styling and beauty station 10 from a vertical position to a substantially horizontal position and securing it in the vehicle.

The loading assembly 30 reduces the risk of harm to the user's vehicle in case of an accident or due to lifting of the hair styling and beauty station 10. The loading assembly also reduces the risk to property and to the hair styling and beauty station 10 itself. The loading assembly 30 is easy to use for all users and can be operated by a single user without lifting or straining. The loading assembly 30 is bolted or otherwise firmly secured to the vehicle.

Other aspects of the loading assembly are as follows:
1) The loading assembly 30 is constructed to accommodate a vehicle bed height of between approximately twenty-four (24) inches and approximately thirty-one (31) inches, although constructing the loading assembly 30 to accommodate other vehicle bed heights is within the scope of the present invention;
2) The loading assembly 30 is secured to the vehicle bed with bolts or other attachment mechanisms;
3) The tilting mechanism of the loading assembly 30 reduces the loading effort such that the hair styling and beauty station 10 passes a loading test where the operation is completed using the effort of two fingers;
4) Mechanical stops on the loading assembly 30 inhibits the hair styling and beauty station 10 from tipping unless the slides or rails are fully extended;
5) A mechanical cam on the loading assembly 30 inhibits the slides from retracting unless the hair styling and beauty station 10 is tilted in the full back position; and
6) The hair styling and beauty station 10 is attached to the loading assembly 10 by rolling the hair styling and beauty station 10 directly against the framework of the loading assembly 30, then securing the hair styling and beauty station 10 using a cinch-type strap and buckle with pull release similar to a seatbelt.

The hair styling and beauty station 10 and loading assembly of the present invention decreases the effort and burden of manually loading the hair styling and beauty station 10 while removing the necessity to balance and support the hair styling and beauty station 10 when sliding the hair styling and beauty station 10 into a vehicle.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. A loading assembly for loading, unloading, and transporting an object, the loading assembly securable to a vehicle, the loading assembly comprising:
an assembly base secured to the vehicle, the assembly base including a frame mounted to the vehicle, the frame having a first frame rail and a second frame rail, the first frame rail and the second frame rail having an angled top portion and an angled bottom portion;
a tilt rack pivotally connected to the assembly base, the tilt rack having a first tilt rail and a second tilt rail, the first tilt rail and the second tilt rail each having an angled top portion and an angled bottom portion, the first tilt rail alignable with the first frame rail and the second tilt rail alignable with the second frame rail;
a podium rack slidable along the assembly base and the tilt rack, the object receivable on the podium rack; and
a first pair of wheels on the podium rack moveable along the first frame rail and the first tilt rail;
a second pair of wheels on the podium rack moveable along the second frame rail and the second tilt rail;
wherein the first pair of wheels and the second pair of wheels are encapsulated between the angled top portions and the angled bottom portions of the frame rails and the tilt rails;
wherein the loading assembly loads the object from an unloaded vertical position to a loaded horizontal position.

2. (canceled)

3. (canceled)

4. The loading assembly of claim 2 wherein the assembly base includes a pair of support arms each having a first end and a second end, wherein the first ends of the support arms are hingedly connected to the frame and the second ends of the support arms are hingedly connected to the tilt rack.

5. The loading assembly of claim 1 and further comprising:
a winch is mounted to the assembly base;
a roller mounted to the assembly base;
a loop formed on the podium rack; and
a cable mounted from the winch, over the roller, and secured to the loop.

6. (canceled)

7. (canceled)

8. The loading assembly of claim 1 wherein the podium rack includes a support frame for supporting the object during loading and unloading.

9-16. (canceled)

17. (canceled)

18. (canceled)

19. (canceled)

20. (canceled)

21. A loading assembly for loading, unloading, and transporting an object, the loading assembly securable to a vehicle, the loading assembly comprising:
an assembly base secured to the vehicle, the assembly base including a frame mounted to the vehicle, the frame having a first frame rail and a second frame rail;
a tilt rack pivotally connected to the assembly base, the tilt rack having a first tilt rail and a second tilt rail, the first tilt rail linearly alignable with the first frame rail and the second tilt rail linearly alignable with the second frame rail; and
a podium rack slidable along the assembly base and the tilt rack, the object receivable on the podium rack;
wherein the loading assembly loads the object from an unloaded vertical position to a loaded horizontal position.

22. The loading assembly of claim 21 wherein the first frame rail and the second frame rail have an angled top portion and an angled bottom portion, wherein the first tilt rail and the second tilt rail have an angled top portion and an angled bottom portion.

23. The loading assembly of claim 22 and further comprising:
a first pair of wheels on the podium rack moveable along the first frame rail and the first tilt rail; and
a second pair of wheels on the podium rack moveable along the second frame rail and the second tilt rail;
wherein the first pair of wheels and the second pair of wheels are encapsulated between the angled top portions and the angled bottom portions of the frame rails and the tilt rails;
